(19) United States
(12) Patent Application Publication
(10) Pub. No.: US 2025/0164369 A1
(43) Pub. Date: May 22, 2025

(54) INSULATION DENSITY MEASURING DEVICE AND METHODS

(71) Applicant: JOHNS MANVILLE, Denver, CO (US)

(72) Inventor: James Justin Evans, Parker, CO (US)

(21) Appl. No.: 18/513,715

(22) Filed: Nov. 20, 2023

(51) Int. Cl. G01N 9/36; G01N 3/08

(52) U.S. Cl. CPC G01N 9/36; G01N 3/08

(57) ABSTRACT

A loose fill insulation density measurement device may include a rigid frame having a length of greater than 16 inches. The frame may include a front surface and a rear surface opposite the front surface. The device may include a plunger assembly that is operably coupled with the frame. The plunger assembly may include a shaft having a proximal end and a distal end. The plunger assembly may include a faceplate coupled with the distal end of the shaft. The faceplate may extend beyond the front surface of the frame. The faceplate and shaft may be translatable relative to the frame along a length of the shaft. The device may include a resilient member disposed rearward of at least a portion of the frame. The resilient member may bias the faceplate away from the front surface of the frame. The resilient member may have a constant spring force.

### BACKGROUND OF THE INVENTION

Buildings and other structures are often insulated using loose fill insulation. For example, a fiberglass based, cellulose fiber based, rock wool based, or other loose-fill insulation may be introduced into wall, ceiling, roof, floor, and/or other open-front structural cavities to insulate the structure. Such loose-fill insulations are typically introduced into building cavities by blowing or spraying small discrete portions of a fibrous or other insulation material or in the form of an admixture of small discrete portions of a fibrous or other insulation material and an adhesive. To be assured that these loose-fill insulations are properly installed and meeting the specifications and performance criteria set for such applications without having to utilize excessive amounts of the loose-fill insulation (which leads to waste), it is important to be able to determine the as-installed properties of the loose-fill insulation (such as, but not limited to, the as-installed thermal rating (R-value), acoustical rating (STC), combustion rating, and/or other as-installed density related property of the loose-fill insulation).

Conventional methods of determining the as-installed values often include a human touching the density and/or R-value based on a perceived tactile feel of the insulation and estimating the density and/or R-value based on the feel. Such techniques are highly inaccurate and often result in underfilled or overfilled cavities. Some techniques involve the use of more precise density measurement devices. However, conventional density measurement devices present several drawbacks. For example, some measurement devices measure differences in pressure across the insulation using a magnehelic gauge. However, such devices require an air compressor and/or generator and an associated power source. These devices are heavy and cumbersome and may be impractical to use when dealing with large structures (e.g., with many stories). Other measurement devices may require careful calibration of one or more gauges and/or require users to use look up tables or other conversion means to determine a value of a given insulation property. Therefore, improvements to insulation property measurement devices are desired.

### BRIEF SUMMARY OF THE INVENTION

Loose fill insulation density measurement devices may include a rigid frame having a length of greater than 16 inches. The frame may include a front surface and a rear surface opposite the front surface. The devices may include a plunger assembly that is operably coupled with the frame. The plunger assembly may include a shaft having a proximal end and a distal end. The plunger assembly may include a faceplate coupled with the distal end of the shaft. The faceplate may extend beyond the front surface of the frame. The faceplate and the shaft may be translatable relative to the frame along a length of the shaft. The devices may include a resilient member disposed rearward of at least a portion of the frame. The resilient member may bias the faceplate away from the front surface of the frame. The resilient member may have a constant spring force.

In some embodiments, the devices may include at least one handle coupled with the rear surface of the frame. The resilient member may include a compression spring. The plunger assembly may include a first housing member that is fixedly coupled with the frame. The first housing member may define an internal cavity. The plunger assembly may include a second housing member that is slidably received within the internal cavity of the first housing member. A bottom end of the second housing member may include a flange. The plunger assembly may include a cap that covers a top end of the internal cavity. The second housing member may be coupled with the shaft. The resilient member may be disposed between the cap and the flange of the second housing member. The cap may be secured to the first housing member using a plurality of fasteners. The faceplate may have a maximum lateral dimension of between 3 inches and 15 inches. The constant spring force of the resilient member may be between 5 N/m and 10 N/m. The plunger assembly may include a plurality of markings corresponding to density measurements, with a respective marking that corresponds to a given density of insulation within a building cavity being visible beyond a housing of the plunger assembly. The devices may include a first side and a second side opposite the first side. The first side may include an R-value guide for a first depth of building cavity. The second side may include an R-value guide for a second depth of building cavity. The devices may have a total weight of no greater than 10 pounds.

Some embodiments of the present technology may encompass methods of measuring a property of loose fill insulation in a building cavity. The methods may include positioning a faceplate of a plunger assembly of an insulation measurement device against an outer surface of loose fill insulation disposed within a building cavity. The methods may include pressing a frame of the insulation measurement device toward the building cavity until a front surface of the frame contacts framing members of the building cavity, causing the faceplate to compress a portion of the loose fill insulation and causing a shaft of the plunger assembly to extend beyond a rear surface of the frame to compress a resilient member. The methods may include determining a property of the loose fill insulation based on a distance by which the shaft of the plunger assembly extends beyond the rear surface of the frame.

In some embodiments, the property of the loose fill insulation may include one or both of a density of the loose fill insulation and an R-value of the loose fill insulation. The building cavity may have a first depth. The frame may be oriented with a first surface of the frame facing upward when pressed against the framing members of the building cavity. The methods may include rotating the frame of the insulation measurement device such that the first surface faces downward. The methods may include measuring a property of loose fill insulation disposed within an additional building cavity. The additional building cavity may have a second depth that is different than the first depth. The first surface may include markings that indicate the property of the loose fill insulation for the first depth. A second surface opposite the first surface may include markings that indicate the property of the loose fill insulation for the second depth. The methods may include determining whether the resilient member is properly calibrated by attaching a weight of a known mass to an end of the plunger assembly opposite the faceplate and determining if the shaft extends beyond a rear surface of the frame by a predetermined calibration distance. The methods may include removing a number of fasteners from a cap that secures the resilient member within a housing of the plunger assembly. The methods may include removing the cap. The methods may include replacing the resilient member with a different resilient member. The methods may include resecuring the cap to the housing of the plunger assembly. The distance by which the shaft of the plunger assembly extends beyond the rear surface of the frame may be determined based on at least one marking that is provided on the plunger assembly, the at least one marking providing an indication of the distance.

Some embodiments of the present invention may encompass methods of manufacturing a loose fill insulation measurement device. The methods may include 3D printing a rigid frame from a polymeric material. The frame may have a length of greater than 16 inches. The frame may include a front surface and a rear surface opposite the front surface. The frame may define an aperture that extends through a thickness of the frame. The methods may include inserting a shaft of a plunger assembly through the aperture. A faceplate may be coupled with a distal end of the shaft. The methods may include coupling the plunger assembly with the frame. The faceplate and the shaft may be translatable relative to the frame along a length of the shaft. The methods may include inserting a resilient member into the plunger assembly. The resilient member may bias the faceplate away from the front surface of the frame.

In some embodiments, 3D printing the rigid frame may include printing a plurality of hollow frame members. The methods may include inserting at least one reinforcement member into a cavity of at least some of the plurality of hollow frame members. The methods may include coupling the plurality of hollow frame members together to form the frame. Each of the at least one reinforcement member may include at least one of fiberglass, carbon fiber, or a metal. Coupling the plunger assembly with the frame may include coupling a first housing member of the plunger assembly with the frame and inserting a second housing member of the plunger assembly into an internal cavity defined by the first housing assembly. Coupling the plunger assembly with the frame may include coupling the shaft with the second housing member and inserting the resilient member into the internal cavity. Coupling the plunger assembly with the frame may include affixing a cap over the internal cavity.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A illustrates a front isometric view of a measurement device according to some embodiments of the present invention.

FIG. 1B illustrates a rear isometric view of the measurement device of FIG. 1A.

FIG. 1C illustrates a side elevation view of the measurement device of FIG. 1A.

FIG. 1D illustrates a cross-sectional side elevation view of the measurement device of FIG. 1A.

FIG. 1E illustrates a cross-sectional top plan view of the measurement device of FIG. 1A.

FIG. 2 is a flowcharting showing operations of a method of measuring a property of insulation according to embodiments of the present invention.

FIG. 3 is a flowcharting showing operations of a method of manufacturing a measurement device according to embodiments of the present invention.

### DETAILED DESCRIPTION OF THE INVENTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the present invention are directed to measurement devices that may be used to measure the density and/or density-related properties of insulation material, such as loose fill insulation material. The measurement devices described herein may be entirely mechanical, without the need for any pneumatic and/or electrical devices. This may enable the measurement devices to be used without any power sources, compressors, or other heavy or cumbersome components, which may increase the portability and ease of use. The measurement devices may also be constructed of lightweight materials that make the measurement device easier to operate and transport. Embodiments of the measurement devices may be used to determine the density or other related property of insulation materials based on how far a biased plunger is displaced upon being pressed against the insulation material. The plunger may be biased using a resilient member that has a constant spring force that enables the plunger to be repeatably displaced by a set distance for different densities of insulation. Embodiments may enable the biased member to be quickly and easily replaced if the resilient member wears out or otherwise exhibits a change in spring constant.

While discussed in terms of measuring the density or related properties of loose fill insulation, it will be appreciated that the measurement devices are not so limited. For example, the measurement devices described herein may be used to measure the density or other related properties of other types of insulation materials and/or non-insulation materials. For example, a spring constant of the resilient member may be selected to measure a density or other property of a given material.

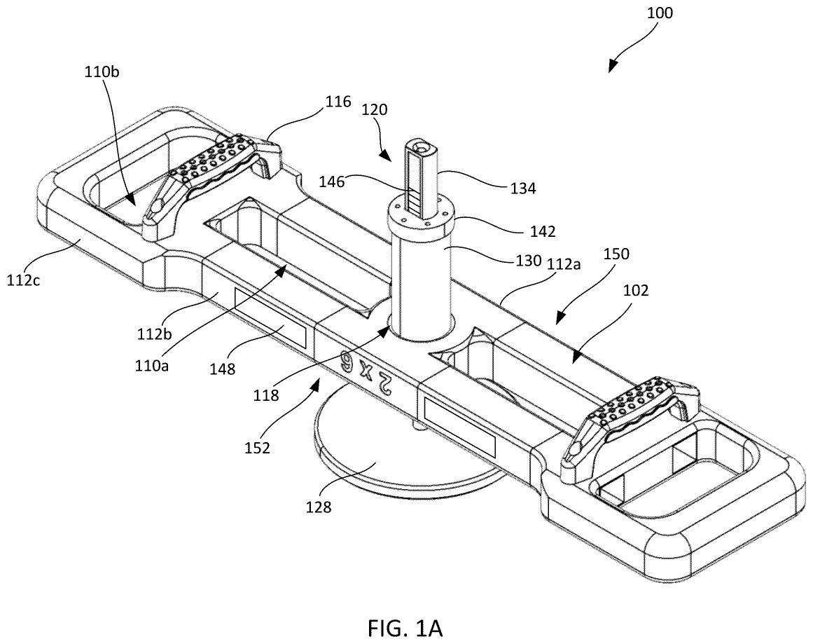

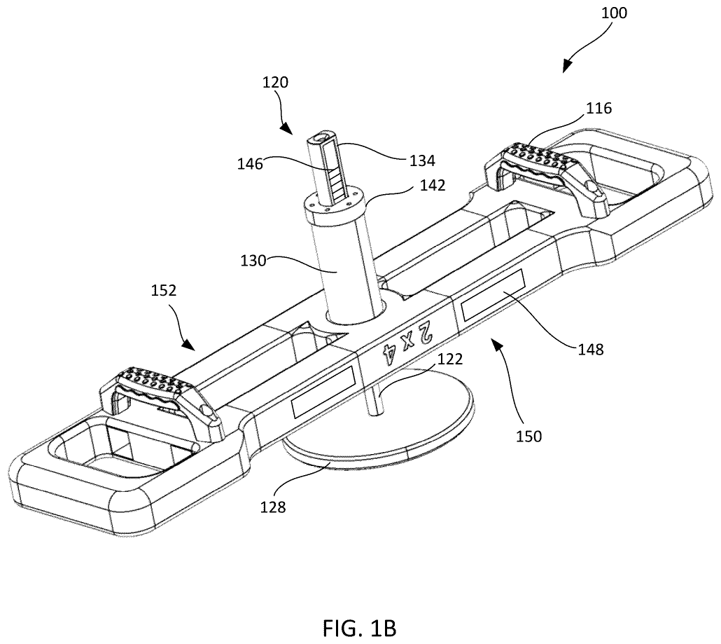

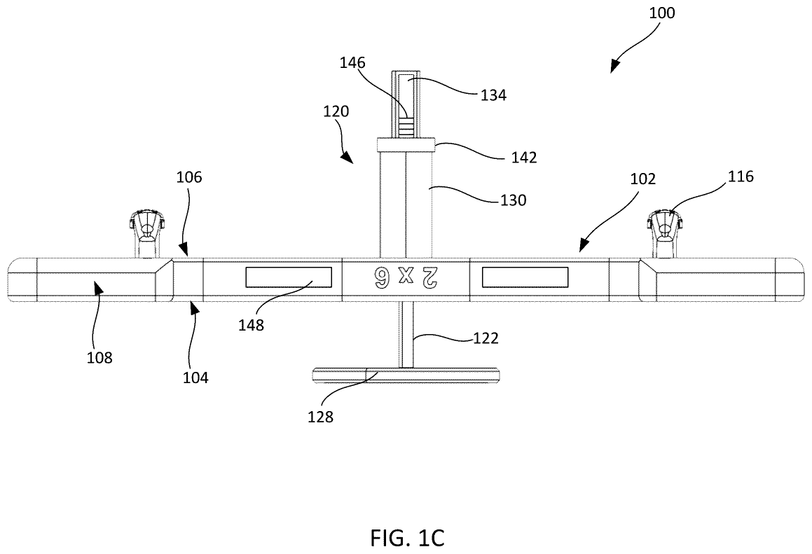

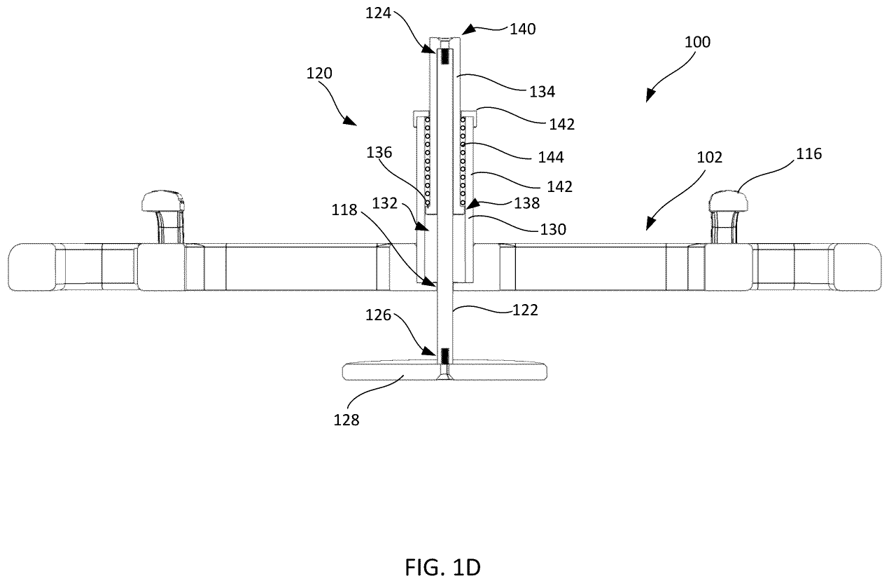

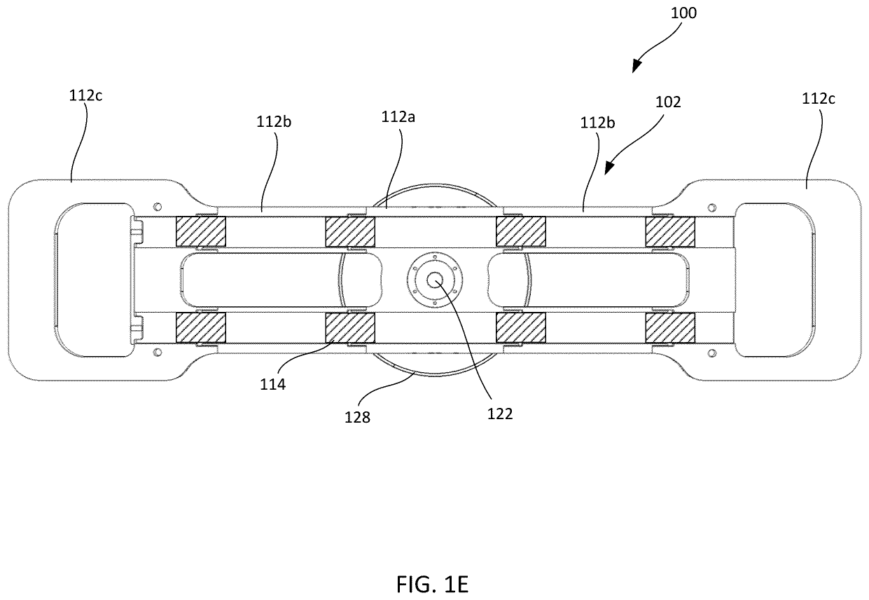

Turning now to FIGS. 1A-1E, one embodiment of a measurement device 100 is illustrated. Measurement device 100 may be used to measure a density or other property (e.g., an R-value, acoustical rating (STC), combustion rating, and/or other density-related property) of installed loose fill material (or other type of insulation material). Measurement device 100 may include a frame 102 that includes a front surface 104 and a rear surface 106 that is positioned opposite the front surface 104. One or more lateral sides 108 may extend between and couple the front surface 104 and the rear surface 106. The front surface 104 of the frame 102 may be positioned against framing members defining a building cavity during use of the measurement device 100. A length of the frame 102 may be selected to be longer than a building cavity in which the insulation is installed. For example, for use with structures having 16 inch on center framing, the frame 102 may have a length of greater than 16 inches (e.g., at least 16.5 inches, at least 18 inches, at least 20 inches, at least 22 inches, at least 24 inches, etc.) and for use with structures have 24 inch on center framing, the frame 102 may have a length of greater than 24 inches (e.g., at least 24.5 inches, at least 26 inches, at least 28 inches, at least 30 inches, etc.). In some embodiments, the frame 102 may have a length of greater than 24 inches such that the measurement device 100 may be utilized with building cavities formed using both 16 inch on center and 24 inch on center framing. It will be appreciated that the length of the frame 102 may be adapted to work with other sizes of cavities in various embodiments.

In some embodiments, the frame 102 may include a number of cutouts 110 that may be spaced apart across the length of the frame 102. Each cutout 110 may extend through all or a portion of the thickness (e.g., from the front surface 104 to the rear surface 106) of the frame 102. The cutouts 110 may be utilized to reduce the weight of the frame 102 while still enabling the frame 102 to be sufficiently rigid. As illustrated, the frame 102 includes two cutouts 110a positioned within a medial portion of the frame 102 on either side of a center of the frame 102. The cutouts 110a may be oriented such that a length of each cutout 110a is aligned with a length of the frame 102. The frame 102 may include two cutouts 110b that are disposed proximate each end of the frame 102. As illustrated, each cutout 110b is oriented such that a length of each cutout 110b is orthogonal relative to a length of the frame 102. In some embodiments, the cutouts 110b may be usable as handles for a user to carry the measurement device 100 to various locations. In some embodiments, each cutout 110 may be generally rectangular in shape, although any shape of cutout may be used. While shown with four cutouts 110, it will be appreciated that any number of cutouts 110 may be included in various embodiments.

In some embodiments, the frame 102 may be made as a single piece of material. In other embodiments, the frame 102 may be formed from multiple smaller pieces. For example, the frame 102 may be formed from a number of frame members 112 that may be coupled together to form the frame 102. In the illustrated embodiment, the frame 102 includes seven frame members 112. For example, as best shown in FIG. 1E, the frame 102 may include a center frame member 112a that is coupled with a number (here four) of medial frame members 112b. In the illustrated embodiment, two medial frame members 112b may be coupled with each lateral end of the center frame member 112a. For example, a proximal end of each medial frame member 112b may be coupled with a lateral end surface of the center frame member 112a. The medial frame members 112b on each end of the center frame member 112a may be spaced apart from one another to define a portion of one of the cutouts 110a. The frame 102 may include two end frame members 112c, with each an inner surface of each end frame member 112c being coupled with distal ends of two of the medial frame members 112b. As illustrated, each end frame member 112c defines a respective one of the cutouts 110b, although more or fewer cutouts are possible in various embodiments.

The frame members 112 may include coupling mechanisms that may be used to secure the various frame members 112 together. For example, at each joint between adjacent frame members 112 may include a protrusion or a recess. Each protrusion may be sized and shaped to be inserted within a given recess, such as via a press fit, to secure adjacent frame members 112 together. In some embodiments, in addition to or as an alternative to the use of protrusions and recesses, fasteners, adhesives, and/or other coupling techniques may be used to secure the different frame members 112 together. In some embodiments, some or all of the frame members 112 may be hollow. An entirety of the frame member 112 may be hollow, or only a portion of each frame member 112, such as a portion near a joint, may be hollow. In some embodiments, the frame 102 may include one or more reinforcement members 114 that may be positioned within the hollow interiors of one or more of the frame members 112. For example, a rod or other member may be inserted within some or all of the hollow interiors. Each reinforcement member 114 may be positioned to reinforce a joint between adjacent frame members 112 to strengthen the frame 102 while enabling the frame members 112 to be hollow and/or formed from lighter materials. For example, the reinforcement members 114 may be formed from a strong, rigid material, such as fiberglass, carbon fiber, metal, and/or other material. The frame members 112 may be formed from various rigid materials. For example, the frame members 112 may be formed from plastic, wood, metal, carbon fiber, and/or other rigid material. In a particular embodiment, the frame members 112 may be formed from a plastic material to help reduce the weight and cost of the measurement device 100. In some embodiments, the measurement device 100 may have a total weight of no greater than 10 pounds, no greater than 9 pounds, no greater than 8 pounds, no greater than 7 pounds, no greater than 6 pounds, no greater than 5 pounds, no greater than 4 pounds, or less.

In some embodiments, the measurement device 100 may include one or more handles 116 that assist a user in transporting and/or operating the measurement device 100. For example, as illustrated, a handle 116 is included on each end of the frame 102, such as on each end frame member 112c. For example, each handle 116 may be coupled with the rear surface 106 of the frame 102. The handles 116 may be fixed in place as shown here or may be movably mounted to the frame 102, such as using one or more hinges. The use of hinges may enable an angle of the handles 116 relative to the frame 102 to be adjusted. In some embodiments, the handles 116 may be coupled with the frame 102 via swivel mechanisms that enable an orientation of each handle 116 to rotate about a center of the handle 116 to enable the user to adjust the handles 116 to an orientation that is ergonomic for a given task. Each handle 116 may be formed from a rigid material, such as plastic, rubber, and/or metal and, in some embodiments, may be coated with a soft material, such as rubber and/or foam to increase the comfort of the handles 116.

The measurement device 100 may include a plunger assembly 120 that is pressed against insulation during operation of the measurement device 100. A magnitude of the displacement of at least a portion of the plunger assembly 120 may be used to determine the density or other related property of the insulation as will be discussed in greater detail below. The plunger assembly 120 may be operably coupled with the frame 102. For example, as best shown in FIG. 1D, the frame 102 may define an aperture 118 that may extend through a thickness of the frame 102, such as from the front surface 104 to the rear surface 106. The aperture 118 may be formed in a central portion of the frame 102, such as through the center frame member 112a. At least a portion of the plunger assembly 120 may extend through and/or be coupled proximate the aperture 118. For example, the plunger assembly 120 may include a shaft 122 that includes a proximal end 124 and a distal end 126 that are spaced apart along a length of the shaft 122. The shaft 122 may be inserted through the aperture 118, with the distal end 126 extending beyond the front surface 104 of the frame 102 and the proximal end 124 extending beyond the rear surface 106 of the frame 102.

A faceplate 128 may be coupled with the distal end 126 of the shaft 122, such as with a rear surface of the faceplate 128 being positioned against the distal end 126 and a front surface of the faceplate 128 facing away from the frame 102. The faceplate 128 and the shaft 122 may be formed integrally or may be separate components that are later joined, such as using one or more fasteners, adhesives, and/or other coupling techniques. The faceplate 128 may be positioned and/or extend beyond the front surface 104 of the frame 102. For example, in some embodiments, a distance between the faceplate 128 and the front surface 104 of the frame 102 may be between 4.25 inches and 5.5 inches, although other distances are possible. Distances between 4.25 inches and 5.5 inches may be particularly useful to enable the measurement device 100 to be used to measure properties of insulation disposed within building cavities formed between both 2×4 framing members and 2×6 framing members. The faceplate 128 and the shaft 122 may be translatable relative to the frame 102 along the length of the shaft 122. This translation may enable the faceplate 128 to be pressed against a surface of insulation material and displaced toward the frame 102, with the amount of displacement of the faceplate 128 and the shaft 122 providing an indication of the density and/or density-related property of the insulation material, as will be discussed in greater detail below.

The front surface of the faceplate 128 may be planar in some embodiments. While illustrated as being circular or disc-shaped, it will be appreciated that the faceplate 128 may take other shapes. In some embodiments, a maximum lateral dimension (e.g., a diameter) of the faceplate 128 may be between 3 inches and 15 inches. With lateral dimensions smaller than 3 inches, pressure applied by the faceplate 128 may force the faceplate 128 to penetrate the insulation material, rather than just pressing against and compressing the insulation. Faceplates having lateral dimensions that are greater than 15 may be difficult or impossible to position within building cavities, and in particular building cavities produced with 16 inch on center framing.

The plunger assembly 120 may include a housing that couples the shaft 122 to the frame 102 and that helps guide translation of the shaft 122 relative to the frame 102. The housing may include a first housing member 130 that may be fixedly coupled with the frame 102. For example, in the illustrated embodiment the rear surface 106 of the frame 102 defines a recess about the aperture 118. A distal end of the first housing member 130 may be disposed within the recess and coupled with the frame 102 (such as with the center frame member 112a). In other embodiments, the first housing member 130 may include a flange that may be positioned against and coupled with the rear surface 106 of the frame 102. Other techniques for joining the first housing member 130 and the frame 102 are possible, and in some embodiments the first housing member 130 and the frame 102 may be integrally formed. The first housing member 130 may be generally tubular in shape and may define an internal cavity 132 that extends along a length of the first housing member 130.

The plunger assembly 120 may include a second housing member 134 that may be slidingly received within the internal cavity 132 of the first housing member 130. The second housing member 134 may include a flange 136 that extends radially outward from an outer surface of the second housing member 134. The flange 136 may be disposed at or near a distal end 138 of the second housing member 134 in some embodiments. A proximal end 140 of the second housing member 134 may be coupled with the proximal end 124 of the shaft 122, such as using one or more fasteners. Once coupled, the second housing member 134 may move along with the shaft 122 as the faceplate 128 and the shaft 122 are displaced during operation of the measurement device 100. The plunger assembly 120 may include a cap 142 that is coupled with the proximal end of the first housing member 130. The cap 142 may close the open proximal end of the first housing member 130 and may prevent the shaft 122 and the second housing member 134 from being removed from the internal cavity 132 and from tilting or moving laterally within the internal cavity 132 relative to a longitudinal axis of the shaft 122. For example, the cap 142 may define a central aperture that is sized and shaped to slidingly receive an outer surface of the second housing member 134. Contact between the outer surface of the second housing member 134 and the cap 142 and contact between an outer surface of the flange 136 and an inner surface of the first housing member 130 may limit or prevent lateral movement and/or tilting of the shaft 122 and the second housing member 134.

The measurement device 100 may include a resilient member 144 that biases the faceplate 128 away from the front surface 104 of the frame 102. In some embodiments, the resilient member 144 may be a compression spring, however other formed of resilient members may be used in various embodiments. The resilient member 144 may have a constant spring force. In some embodiments, the spring force of the resilient member 144 may be between 5 N/m and 10 N/m, between 6 N/m and 9.5 N/m, between 7 N/m and 9 N/m, or between 7.5 N/m and 8.5 N/m. In a particular embodiment, a spring force of the resilient member 144 may be 8.5 N/m. Spring forces within the above ranges may enable the measurement device 100 to be utilized to measure the density (or other related property) of installed insulation for multiple depths of building cavities, such as for cavities formed using 2×4 framing members and 2×6 framing members. It will be appreciated that other spring forces may be utilized in various embodiments to enable the measurement device 100 to measure one or more properties of insulation or other materials at one or more different depths or thicknesses. Spring forces that are too high may reduce the sensitivity of measurements of the measurement device 100.

The resilient member 144 may be positioned on or beyond the rear surface 106 of the frame 102. For example, in the illustrated embodiment the resilient member 144 is disposed within the internal cavity 132, with one end of the resilient member 144 being positioned against an inner surface of the cap 142 and the other end of the resilient member 144 being positioned against a top surface of the flange 136. During operation of the measurement device 100, as the faceplate 128 is pressed against an insulation material, the insulation material may cause the faceplate 128 and the shaft 122 to be displaced toward the frame 102, which may cause the resilient member 144 to be compressed between the flange 136 and the cap 142. The spring force of the resilient member 144 may be selected such that the magnitude of the displacement of the shaft 122 and the faceplate 128 against the spring force may be indicative of the density of the insulation material. For example, insulation materials with lower densities may be compressed more by the faceplate 128 (that is biased by the spring force of resilient member 144), resulting in a smaller displacement of the faceplate 128 and the shaft 122. Insulation materials with higher densities may be compressed less by the faceplate 128 and may overcome the spring force of resilient member 144 to a greater degree, resulting in a smaller displacement of the faceplate 128 and the shaft 122.

The measurement device 100 may include a number of markings and/or guides that indicate a measurement of a density or density-related property of insulation material. For example, an exterior surface of the second housing member 134 may include a number of markings 146 disposed along a length of the second housing member 134. Each marking 146 may correspond with a given density of insulation within a building cavity. A position of each marking 146 may be selected such that for a given thickness of insulation/depth of building cavity, visible exposure of a given marking 146 and/or alignment of the marking 146 with the proximal end of the cap 142 indicates a given density measurement and/or density-related property (e.g., R-value, acoustical rating (STC), combustion rating, etc.) of the insulation. In some embodiments, the first housing member 130 may be transparent and the markings 146 may be aligned with a corresponding marking formed on the first housing member 130 to indicate the density and/or other density-related property of the insulation. Other marking/measurement techniques may be used in various embodiments.

As noted above, each marking 146 may indicate a given density measurement and/or density-related property of the insulation. In a particular embodiment, the markings 146 may indicate a density measurement of the insulation. The measurement device 100 may include one or more guides 148 that may be used to convert the density measurements to one or more density-related properties. For example, a user may use a guide 148 to look up an R-value measurement that corresponds to a density measurement indicated by the relevant marking 146. Any number of guides 148 may be provided, such as a guide for an R-value, a guide for an acoustical rating, and/or a guide for a combustion rating. In some embodiments, one or more guides 148 may include multiple density-related properties. In other embodiments, the markings 146 may directly indicate a value of multiple properties of the insulation such that no guides are needed. For example, each marking 146 may include one or more labels that indicate a value for a given insulation property.

In some embodiments, the measurement device 100 may be dual-sided, with each side of the measurement device 100 containing different markings 146 and/or guides 148. For example, the measurement device 100 may include a first side 150 and a second side 152 positioned opposite the first side 150. An exterior surface of the second housing member 134 on the first side 150 may include markings 146 that correspond to density and/or density-related properties of insulation for a first depth of building cavity (e.g., a building cavity formed by 2×4 framing members). The surface of the frame 102 and/or first housing member 130 facing the first side 150 may include guides 148 that correspond to the density and/or density-related properties of insulation for the first depth of building cavity. An exterior surface of the second housing member 134 on the second side 152 may include markings 146 that correspond to density and/or density-related properties of insulation for a second depth of building cavity (e.g., a building cavity formed by 2×6 framing members). The surface of the frame 102 and/or first housing member 130 facing the second side 152 may include guides 148 that correspond to density and/or density-related properties of insulation for the second depth of building cavity. Such a design may enable the measurement device 100 to be used to measure the density and/or density-related properties of insulation in two different depths of building cavities. For example, the measurement device 100 may be held by a user with the first side 150 facing upward (and the second side 152 facing downward) and/or with the first side 150 otherwise facing the user when measuring a property of insulation material provided within a first depth of building cavity and may be rotated such that the second side 152 faces upward (and the first side 150 faces downward) and/or with the second side 152 otherwise facing the user when measuring a property of insulation material provided within a second depth of building cavity. To enable the markings 146 on the second housing member 134 to be properly oriented relative to the first side 150 and/or the second side 152, the second housing member 134 may be noncircular and/or may include one or more tracks or guides that enable the second housing member 134 to translate longitudinally relative to the first housing member 130 while preventing rotation of the second housing member 134 relative to the first housing member 130 to maintain the markings 146 in proper alignment with a corresponding side (e.g., first side 150 or second side 152) of the measurement device 100.

The spring force of the resilient member 144 may be selected to accurately measure the density and/or density-related properties of insulation for both depths of building cavities. Such designs may enable the measurement device 100 to be used with different depths of building cavities by merely changing an orientation of the measurement device 100 without the need to recalibrate or otherwise adjust the measurement device 100. While discussed in terms of 2×4 and 2×6 framed building cavities, it will be appreciated that the measurement device 100 may be designed for use with building cavities formed by other sizes of framing members.

In some embodiments, the resilient member 144 may be removable from the plunger assembly 120. For example, the cap 142 may be coupled with the first housing member 130 via one or more fasteners or other reversible coupling mechanisms. The fasteners may be removed to allow the cap 142 to be removed, which may enable the resilient member 144 to be accessed for replacement. For example, over time, the resilient member 144 may lose elasticity and/or otherwise change, resulting in a change of spring force. The change in spring force may result in the measurement device 100 may lose accuracy. When this happens, the resilient member 144 may be replaced with a new resilient member having a predetermined spring force. To determine whether the resilient member 144 has the propre predefined spring force, a weight of a predetermined mass may be attached to the proximal end of 140 of the second housing member 134 and/or the proximal end 124 of the shaft 122. The measurement device 100 may be oriented such that the faceplate 128 points upward, which may cause the weight to pull the second housing member 134 and the shaft 122 downward against the force of the resilient member 144. If the displacement of the second housing member 134 and the shaft 122 exposes a calibration marking (which may be one of markings 146 or a separate marking) formed on the second housing member 134 and/or the shaft 122 and/or aligns the calibration marking with the proximal end of the cap 142 (or other reference point), the measurement device 100 may be properly calibrated. If the calibration marking is covered by the cap 142 and/or first housing member 130 and/or is offset from the proximal end of the cap 142 (or other reference point), the measurement device 100 may be uncalibrated and the resilient member 144 may need to be replaced. As noted above, to replace the resilient member 144, fasteners may be removed from the cap 142 and the cap 142 may be removed from the first housing member 130. The resilient member 144 may be removed and replaced with a different resilient member and the cap 142 may be resecured to the first housing member 130 of the plunger assembly 120, such as by tightening the fasteners. It will be appreciated that other forms of calibrating the measurement device 100 may be utilized in various embodiments.

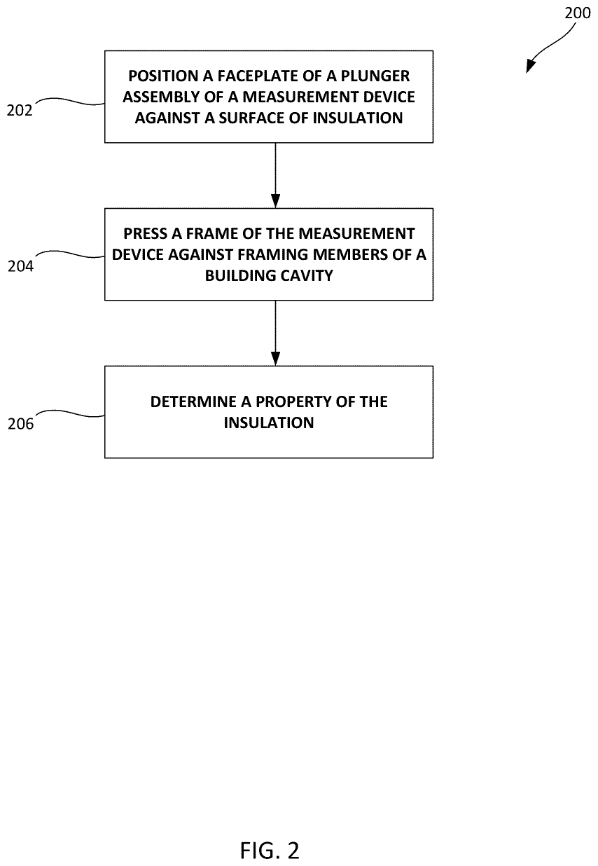

FIG. 2 is a flowchart illustrating a method 200 of measuring a property of loose fill insulation (or other insulation) within a building cavity. The property of the insulation may include a density and/or density-related property of the insulation installed within the building cavity. Method 200 may be performed using a measurement device, such as measurement device 100 described herein. Method 200 may begin at operation 202 by positioning a faceplate of a plunger assembly of an insulation measurement device against an outer surface of loose fill insulation disposed within a building cavity. In some embodiments, the insulation may be disposed within the building cavity such that the outer surface of the insulation is coplanar with or substantially coplanar (e.g., within 1 inch, within 0.75 inch, within 0.5 inch, within 0.25 inch, or less) an outer surface of the framing members of the building cavity. The faceplate may be positioned between two adjacent framing members, such as within a center of the building cavity (although other locations are possible in various embodiments).

At operation 204, a frame of the measurement device may be pressed toward the building cavity until a front surface of the frame contacts framing members of the building cavity. For example, opposing ends of the frame may extend over the entire width of the building cavity and contact adjacent framing members on opposite sides of the building cavity, which may limit the penetration depth of the faceplate into the insulation. The faceplate may press against the outer surface of the insulation, which may cause the faceplate to compress a portion of the loose fill insulation. Once the faceplate compresses the insulation to a certain point (which depends on the density of the insulation), a rebound force of the compressed insulation is greater than a spring force of the resilient member that biases the faceplate away from the frame. At this point, the rebound force of the compressed insulation begins to force the faceplate and the shaft of the measurement device to be displaced in a direction away from the building cavity (e.g., toward the frame of the measurement device). This displacement may cause the shaft of the plunger assembly to extend rearward and/or beyond a rear surface of the frame to compress the resilient member.

A property of the loose fill insulation may be determined based on a distance by which the shaft of the plunger assembly extends beyond the rear surface of the frame at operation 206. For example, as the shaft of the plunger assembly extends beyond the frame, the shaft and/or a housing member (such as the second housing member 134) may protrude beyond the frame and/or a fixed housing member (such as the first housing member 130). The shaft, second housing member, and/or other portion of the plunger assembly may include a number of markings (such as markings 146) that may become visible beyond the frame and/or first housing member (or a cap coupled therewith), with each marking indicating a given density measurement and/or measurement of a density-related property of the insulation material. The marking that is aligned with a given reference point (such as a proximal end of the cap and/or a marking on the first housing member) indicates the value of the given property or properties of the insulation material. In some embodiments, the markings on the shaft and/or second housing member may only show a portion of the measurements provided by the measurement device. For example, the frame and/or plunger assembly may include one or more guides that enable a user to determine a measurement of one or more additional properties based on the measurement indicated by the markings on the second housing member and/or shaft. As just one example, the markings on the shaft and/or second housing member may indicate a density of the insulation. A user may determine the density of the insulation based on the markings and then reference a lookup table that correlates the density with one or more other properties (e.g., R-value, acoustical rating, combustion rating, etc.) of the insulation to determine the additional measurements of the insulation material. It will be appreciated that any combination of correlated measurements may be provided on the markings and/or guides. In some embodiments, rather than having a measurement of a property of the insulation on the markings, the markings may just indicate a distance or other indexed value that may correspond to one or more measurements provided on a lookup table or other guide.

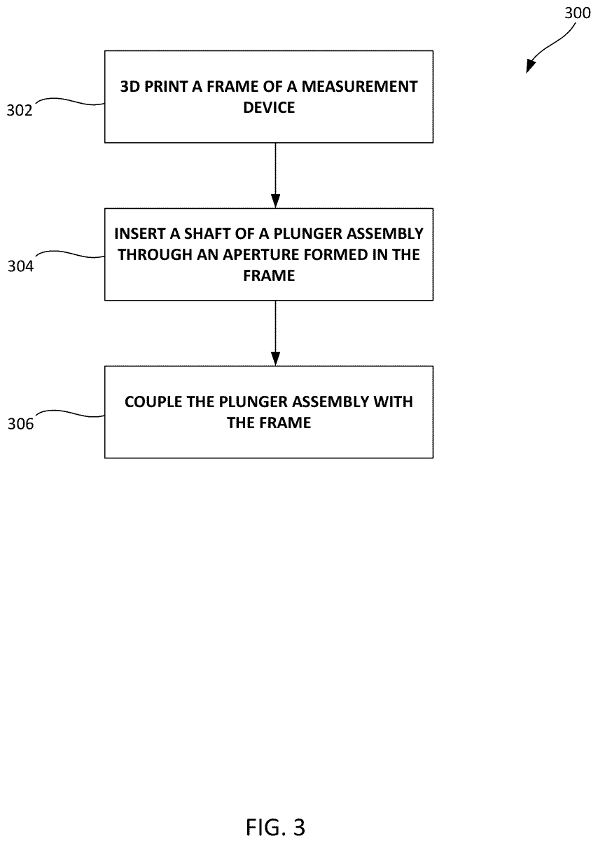

The measurement device described herein, such as measurement device 100, may be manufactured using various techniques. For example, one or more of the components may be molded, machined, extruded, 3D printed, and/or otherwise formed. As shown in FIG. 3, in a particular embodiment, a method 300 of manufacturing a measurement device may include 3D printing a frame (such as frame 102) from a polymeric material, such as a plastic, at operation 302. In some embodiments, the frame may be printed as a single monolithic piece. In other embodiments, the frame may be printed in several pieces and later assembled. For example, a number of separate frame members (such as frame members 112) may be printed individually. Some or all of the frame members may include coupling mechanisms, such as protrusions and recesses, that may enable adjacent frame members to be secured together to form the frame, with or without additional coupling techniques such as fasteners and/or adhesives. In some embodiments, a portion (or all) of some or all of the frame members may be hollow. In some such embodiments, reinforcement members may be inserted within the hollow interiors of at least some of the frame members, such as near joints of adjacent frame members. The reinforcement members may strengthen the joints and frame, while enabling lighter, hollow, cheaper, and/or weaker materials to be used for the majority of frame and/or at least critical locations. In embodiments that include reinforcement members, the reinforcement members may be inserted within the hollow interiors prior to coupling the frame members together to form the frame.

At operation 304, a shaft of a plunger assembly may be inserted through an aperture (such as aperture 118) formed through the frame. A faceplate may be coupled with a distal end of the shaft (e.g., using fasteners, integral formation, etc.) and may be positioned on a front side of the frame. At operation 306, a plunger assembly (which may include the shaft and the faceplate) may be coupled with the frame. For example, a first housing member (such as first housing member 130) of the plunger assembly may be coupled with the frame, such as using one of more fasteners. A second housing member (such as second housing member 134) of the plunger assembly may be inserted into an internal cavity defined by the first housing assembly. The shaft may be coupled with the second housing member, such as by using one or more fasteners. A resilient member (such as resilient member 144) may be inserted into the internal cavity, such as against a top surface of a flange formed one the first housing member. A cap may be affixed over the internal cavity, which may constrain the resilient member between the cap and the flange.

It will be appreciated that the manufacturing technique described above is merely provided as one example and that numerous variations exist. For example, one or more components may be formed using techniques other than 3D printing. Additionally, the first housing member and/or other portion of the plunger assembly may be integrally formed with the frame. Similarly, the shaft and second housing member may be formed as a single component in some embodiments. Additionally, while being described as being formed from plastic, the frame and/or plunger assembly may be formed from any rigid material.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having disclosed several embodiments, it will be recognized by those of skill in the art that various modifications, alternative constructions, and equivalents may be used without departing from the spirit of the embodiments. Additionally, a number of well-known processes and elements have not been described in order to avoid unnecessarily obscuring the present technology. Accordingly, the above description should not be taken as limiting the scope of the technology.

The methods, systems, and devices discussed above are examples. Some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. It will be further appreciated that all testing methods described here may be based on the testing standards in use at the time of filing or those developed after filing.

It should be noted that the systems and devices discussed above are intended merely to be examples. It must be stressed that various embodiments may omit, substitute, or add various procedures or components as appropriate. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included.

As used herein and in the appended claims, the singular forms “a”, “an”, and “the” include plural references unless the context clearly dictates otherwise. Thus, for example, reference to “a heater” includes a plurality of such heaters, and reference to “the protrusion” includes reference to one or more protrusions and equivalents thereof known to those skilled in the art, and so forth.

Also, the words “comprise(s)”, “comprising”, “contain(s)”, “containing”, “include(s)”, and “including”, when used in this specification and in the following claims, are intended to specify the presence of stated features, integers, components, or operations, but they do not preclude the presence or addition of one or more other features, integers, components, operations, acts, or groups.

What is claimed is:

1. A loose fill insulation density measurement device, comprising:
a rigid frame having a length of greater than 16 inches, the frame comprising a front surface and a rear surface opposite the front surface;
a plunger assembly that is operably coupled with the frame, wherein:
the plunger assembly comprises a shaft having a proximal end and a distal end;
the plunger assembly comprises a faceplate coupled with the distal end of the shaft;
the faceplate extends beyond the front surface of the frame;
the faceplate and the shaft are translatable relative to the frame along a length of the shaft;
a resilient member disposed rearward of at least a portion of the frame, wherein:
the resilient member biases the faceplate away from the front surface of the frame; and
the resilient member has a constant spring force.

2. The loose fill insulation density measurement device of claim 1, further comprising:
at least one handle coupled with the rear surface of the frame.

3. The loose fill insulation density measurement device of claim 1, wherein:
the resilient member comprises a compression spring.

4. The loose fill insulation density measurement device of claim 1, wherein:
the plunger assembly comprises:
a first housing member that is fixedly coupled with the frame, the first housing member defining an internal cavity; and
a second housing member that is slidably received within the internal cavity of the first housing member, a bottom end of the second housing member comprising a flange;
a cap that covers a top end of the internal cavity;
the second housing member is coupled with the shaft; and
the resilient member is disposed between the cap and the flange of the second housing member.

5. The loose fill insulation density measurement device of claim 4, wherein:
the cap is secured to the first housing member using a plurality of fasteners.

6. The loose fill insulation density measurement device of claim 1, wherein:
the faceplate has a maximum lateral dimension of between 3 inches and 15 inches.

7. The loose fill insulation density measurement device of claim 1, wherein:
the constant spring force of the resilient member is between 5 N/m and 10 N/m.

8. The loose fill insulation density measurement device of claim 1, wherein:
the plunger assembly comprises a plurality of markings corresponding to density measurements, with a respective marking that corresponds to a given density of insulation within a building cavity being visible beyond a housing of the plunger assembly.

9. The loose fill insulation density measurement device of claim 1, wherein:
the measurement device comprises a first side and a second side opposite the first side;
the first side comprises an R-value guide for a first depth of building cavity; and
the second side comprises an R-value guide for a second depth of building cavity.

10. The loose fill insulation measurement device of claim 1, wherein:
the measurement device has a total weight of no greater than 10 pounds.

11. A method of measuring a property of loose fill insulation in a building cavity, comprising:
positioning a faceplate of a plunger assembly of an insulation measurement device against an outer surface of loose fill insulation disposed within a building cavity;
pressing a frame of the insulation measurement device toward the building cavity until a front surface of the frame contacts framing members of the building cavity, causing the faceplate to compress a portion of the loose fill insulation and causing a shaft of the plunger assembly to extend beyond a rear surface of the frame to compress a resilient member; and
determining a property of the loose fill insulation based on a distance by which the shaft of the plunger assembly extends beyond the rear surface of the frame.

12. The method of measuring a property of loose fill insulation in a building cavity of claim 11, wherein:
the property of the loose fill insulation comprises one or both of a density of the loose fill insulation and an R-value of the loose fill insulation.

13. The method of measuring a property of loose fill insulation in a building cavity of claim 11, wherein:
the building cavity has a first depth;
the frame is oriented with a first surface of the frame facing upward when pressed against the framing members of the building cavity;
the method further comprises:
rotating the frame of the insulation measurement device such that the first surface faces downward; and
measuring a property of loose fill insulation disposed within an additional building cavity, wherein the additional building cavity has a second depth that is different than the first depth; and
the first surface comprises markings that indicate the property of the loose fill insulation for the first depth; and
a second surface opposite the first surface comprises markings that indicate the property of the loose fill insulation for the second depth.

14. The method of measuring a property of loose fill insulation in a building cavity of claim 11, further comprising:
determining whether the resilient member is properly calibrated by:
attaching a weight of a known mass to an end of the plunger assembly opposite the faceplate; and
determining if the shaft extends beyond a rear surface of the frame by a predetermined calibration distance.

15. The method of measuring a property of loose fill insulation in a building cavity of claim 11, further comprising:
removing a number of fasteners from a cap that secures the resilient member within a housing of the plunger assembly;
removing the cap;
replacing the resilient member with a different resilient member; and
resecuring the cap to the housing of the plunger assembly.

16. The method of measuring a property of loose fill insulation in a building cavity of claim 11, wherein:
the distance by which the shaft of the plunger assembly extends beyond the rear surface of the frame is determined based on at least one marking that is provided on the plunger assembly, the at least one marking providing an indication of the distance.

17. A method of manufacturing a loose fill insulation measurement device, comprising:
3D printing a rigid frame from a polymeric material, wherein:
the frame has a length of greater than 16 inches;
the frame comprises a front surface and a rear surface opposite the front surface; and
the frame defines an aperture that extends through a thickness of the frame;
inserting a shaft of a plunger assembly through the aperture, wherein a faceplate is coupled with a distal end of the shaft;
coupling the plunger assembly with the frame, wherein the faceplate and the shaft are translatable relative to the frame along a length of the shaft; and
inserting a resilient member into the plunger assembly, wherein the resilient member biases the faceplate away from the front surface of the frame.

18. The method of manufacturing a loose fill insulation measurement device of claim 17, wherein:
3D printing the rigid frame comprises printing a plurality of hollow frame members; and
the method further comprises:
inserting at least one reinforcement member into a cavity of at least some of the plurality of hollow frame members; and
coupling the plurality of hollow frame members together to form the frame.

19. The method of manufacturing a loose fill insulation measurement device of claim 18, wherein:
each of the at least one reinforcement member comprises at least one of fiberglass, carbon fiber, or a metal.

20. The method of manufacturing a loose fill insulation measurement device of claim 17, wherein:
coupling the plunger assembly with the frame comprises:
coupling a first housing member of the plunger assembly with the frame;
inserting a second housing member of the plunger assembly into an internal cavity defined by the first housing assembly;
coupling the shaft with the second housing member;
inserting the resilient member into the internal cavity; and
affixing a cap over the internal cavity.
